(19) United States
(12) Patent Application Publication
(10) Pub. No.: US 2019/0222693 A1
(43) Pub. Date: Jul. 18, 2019

(54) FACILITATION FOR A USER WHEN DIALLING

(71) Applicant: Håkan Johan LÖFHOLM, Huddinge (SE)

(72) Inventor: Håkan Johan LÖFHOLM, Huddinge (SE)

(21) Appl. No.: 16/314,201

(22) PCT Filed: Oct. 5, 2016
(86) PCT No.: PCT/EP2016/073767

§ 371 Date: Dec. 28, 2018

(51) Int. Cl. H04M 3/493; H04M 3/42; H04M 1/725

(52) U.S. Cl. CPC H04M 3/493; H04M 3/42161; H04M 2203/1016; H04M 2250/66; H04M 1/72583

(57) ABSTRACT

A method performed by a mobile device includes
dialling a telephone number belonging to a dialled party, querying a database or a server having a list of telephone numbers as to whether the dialled number is in the list. If the telephone number is in the list, then activating and/or displaying at least a keypad of the mobile device automatically without involving a user of the mobile device and simultaneously activating a speaker of the mobile device. The activating and/or displaying the keypad enabling the user to select or push on at least a key of the keypad. The selected or pushed key of the keypad being requested by the dialled party. Simultaneously activating the speaker enabling the user to hear the dialled party requesting the user of the mobile device to select or push the requested at least one key of the keypad.

### TECHNICAL FIELD

The present invention generally relates to facilitating for a user of a mobile device and more particularly to a method performed by a mobile device; a mobile device, a computer program and a carrier, for facilitating for a user when dialling a mobile number or a telephone number belonging i.e. comprised in a list of mobile numbers or telephone numbers.

### BACKGROUND

In today's mobile or radio technologies, the society and technology almost forces a mobile user to make use of mobile services offered for example by a bank, or an insurance company etc. With today's smart phones, there exist applications stores for downloading an application of interest. An example of an application is handling a bank account of the mobile user. Another example of an application is performing tax declaration. Another example of a downloadable application is to find a person or a company that calls or dials the number of the owner of the device in order to facilitate the owner or user of the device to know beforehand who called. Example of application stores can be Play boutique managed by Google® or App Store managed by Apple®.

Since more and more companies whether it is a bank or an insurance company, an authority like the police, a hospital, a care centre, an airport etc., are keen to make use of mobile services and the internet to offer their respective customers/users/clients a fast service, a mobile user is almost obliged to make use of its telephone or mobile phone or mobile device in order to take part of the above mentioned services. As an example, a mobile user driving a car gets a problem on the highway and possibly gets injured. The mobile user calls, by means of a mobile device, the insurance company or the hospital or police and often an automatic voice answers the call giving instructions to the user to push a key on the keypad to select the appropriate action to be performed in such a situation. The user then enters or pushes the appropriate key and await for additional instructions and hopefully gets the help he/she needs. For example, the mobile user is requested to push/enter key 9 in case he wishes the instructions to be in another language e.g. in Swedish. After that the mobile user is requested to push/enter on an additional number e.g. key 1 to get in contact with a person. Also sometimes the mobile user is requested to enter his or hers social security number (e.g. “personnummer” as it is called in Sweden) before he or she is instructed to push on e.g. key 1 described above. The scenario above is applicable when contacting an insurance company or a mobile operator or a bank or an institution, where the mobile user is already registered. There are of course many other companies etc. that apply the same principle. This is a kind of harmonization system that facilitates for a calling party (here e.g. a mobile user) when contacting a called party.

Although the solution or method above facilitates for a mobile user to get in touch in an appropriate way with a requested party, there is problem with the above solution or service which involves delays. Another problem is that the service provided by the company or authority etc. maybe is not suitable for the particular situation the user is in when dialling the mobile number or telephone number of the dialled party i.e. the number of the authority or of the company etc.

As an example, the user may be injured and may not be capable to perform in a simple way all the instructions giving to him/he by the dialled party.

There is therefore need for a method, a mobile device, a computer program and a carrier containing the computer program to further reduce delay when contacting a dialled number and for further facilitating for the user of the mobile device to get in contact with the dialled party in a simpler way than what is offered with today's solution.

### SUMMARY

The present invention provides a method, a mobile device, a computer program and a carrier comprising the computer program for achieving the above.

According to an aspect of embodiments herein there is provided a method comprising: dialling a mobile number or telephone number belonging to a dialled party; querying a database or a server comprising a list of telephone numbers or mobile numbers on whether the dialled mobile or telephone number is comprised in said list; that being the case i.e. if the mobile number or the telephone number is comprised in said list, activating and/or displaying at least a keypad of the mobile device automatically without involving a user of the mobile device; enabling the user to select or push on at least a key of the keypad; wherein the selected or pushed key of the keypad being requested by the dialled party.

According to another aspect of embodiments herein there is provided a mobile device configured to: dial a mobile number or telephone number belonging to a dialled party; query a database or a server comprising a list of telephone numbers or mobile numbers on whether the dialed mobile or telephone number is comprised in said list; and that being the case i.e. if the mobile number or the telephone number is comprised in said list, activate and/or display at least a keypad of the mobile device automatically without involving a user of the mobile device; enabling the user to select or push on at least a key of the keypad; wherein the selected or pushed key of the keypad being requested by the dialled party.

According to yet another aspect of embodiments herein there is provide a mobile device (200) comprising a processor and a memory, said memory containing instructions executable by said processor whereby said mobile device is operative to: dial a mobile number or telephone number belonging to a dialled party; query a database or a server comprising a list of telephone numbers or mobile numbers whether the dialled mobile or telephone number is comprised in said list; and that being the case i.e. if mobile number or telephone number is comprised in said list, activate and/or display at least a keypad of the mobile device automatically without involving a user of the mobile device; enabling the user to select or push on at least a key of the keypad; wherein the selected or pushed key of the keypad being requested by the dialled party.

Yet another aspect of embodiments herein, there is provided a computer program comprising instructions which, when executed on at least one processor, cause the at least one processor to carry out the method according to any one of appended claims 1-8 at the end of this application.

Yet another aspect of embodiments herein, there is provided a carrier containing the computer program described above, wherein the carrier is one of an electronic signal, optical signal, radio signal, or computer readable storage medium.

An advantage with the present embodiments is to reduce significantly the delay for a user of a mobile device to get the appropriate help.

Another advantage with the present embodiments is to simplify for the user of the device to get in contact with the dialled party in a faster way than what is offered with today's solution. Another advantage with the present embodiments is to provide the dialled party (company or authority or hospital etc. to which the dialler party calls) with a service that helps the dialler getting the appropriate help in a faster needed thereby improving the service offered by the dialled party and thus improving the dialler party's experience.

Yet another advantage with the present embodiments is to provide a mobile user with a downloadable application that can easily be installed and started in a mobile device of the user enabling the user to automatically, without involvement of the user i.e. the dialler party, display and/or activate a keypad of the device and optionally automatically activate a speaker of the mobile device enabling the user to not only see the keypad for appropriate action as described above but also hear the dialled party giving information and/or instructions to the mobile user.

Other advantages of the present embodiments will be clear for a reader of this application/invention.

### BRIEF DESCRIPTION OF THE DRAWINGS

FIG. 1 is a flow diagram of exemplary embodiments of a method according to the present invention.

FIG. 2 is a flow diagram of an exemplary embodiment of a method according to the present invention.

FIG. 3 is a block diagram of exemplary embodiments of an apparatus, mobile device, according to the present invention.

FIG. 4 is another block diagram of an exemplary embodiment of an apparatus, mobile device, of the present invention.

### DETAILED DESCRIPTION

The present invention relates to facilitating for a user of a mobile device and more particularly to a method performed by a mobile device; a mobile device, a computer program and a carrier, for facilitating for a user when dialling a mobile number or a telephone number belonging i.e. comprised in a list of mobile numbers or telephone numbers.

The mobile number of phone number may be a number to a bank or an authority or an insurance company or any suitable party to which a mobile user can call or dial to and where the dialled party requests by automatic voice or the like the dialler party (the mobile user) to enter/activate or push a key of a keypad of the mobile device of the mobile user. Several examples illustrative and descriptive will be given below to better understand the invention.

Assuming a mobile user wishes to call to an insurance company for some reason(s). The mobile user selects the telephone number or mobile number of the insurance company from the user's contact list in his mobile device or the user enters by touch or voice the number or name of the insurance company. Entering by touch the number of the insurance company may be performed by use of the keypad of the mobile device. The mobile user may, if his/her mobile device is an advance smart phone, to speak up the name of the insurance company so the mobile device itself dials/calls the insurance company. It is here assumed that the number of the insurance company is comprised in a list or database or server and that the dialler party queries the database or server to check whether the number of the dialled party is comprised in said list. That being the case i.e. the mobile or telephone number is comprised in the list or database or server, the dialled party offers the dialler party with an automatic voice service enabling the dialler party to present options for the dialler party so that the later may select appropriate key or keys depending on what the dialler party request for particular service of the dialled party.

When the insurance company, herein the dialled party, answers the mobile user, herein the dialler party, an automatic voice starts by presenting (though voice) options to select among. For example the voice may say press “1” for coming in contact with the part of the insurance company handling car accidents; or say press “2” for home related insurance questions; or say press “3” for travel related issues etc.

Hence the dialler party need to (actively) select one of the options above, which in this example is “1” or “2” or “3”. A selection may be made via voice of the dialler party or by touch of the dialler party.

According to an embodiment herein, at least the keypad of the mobile device of the dialler party is activated and/or displayed. Display of the keypad enable the dialler party to make the selection described above. Hence, without the dialler party activating the keypad, less time it takes for the user to make the selection of the key to be pressed or said. In other words, the keypad is automatically activated and/or displayed without involvement of the dialler party.

According to another embodiment herein, the speaker of the mobile device of the dialler party is simultaneously activated together with the activation of the keypad. Hence, in this embodiment the speaker and the keypad are activated simultaneously. The keypad is displayed and the speaker is activated enabling the user to hear the dialled party e.g. to hear relatively loudly the automatic voice presenting options to select among as described above; and enabling the user to select the key to press. This embodiment further reduces the delay it takes to get the help needed by the insurance company in this example.

Assume for example the dialler party is driving a car and is calling the insurance company. With the present invention according to the embodiment described above, the driver does not need to actively activate the keyboard and the speaker. The driver only needs a 2-step process which includes: 1) dialling (by touch or voice) the number (or name in case of voice) of the insurance company and 2) pressing by the user the selected key of the keypad. Note that activation/display of the keypad may be performed after activation of the speaker. The order is not restrictive to this invention. It is however considered more appropriate to activate/display the keyboard first since the dialler party normally may hear the dialled party. Note however that as described above, in an embodiment, the keyboard is activated/displayed and at the same time or very shortly (after few milliseconds e.g. 1), the speaker is activated.

In another alternative, the speaker is activated after dialling the dialled party and displaying/activation of the keyboard also here preferably simultaneously or after few milliseconds e.g. 1 ms or 2 ms. Hence the present invention is not restricted to the actual order of activation.

Note that pressing the appropriate key or keys of the keypad may be performed via voice or via touch depending on the features supported by the mobile device and selected by the mobile user. Hence a better wording is selecting the key or keys of the keyboard. Selection herein includes pushing (or pressing) the appropriate key or keys or selection includes saying through voice the appropriate key or keys of the keyboard.

Let us demonstrate the advantage(s) achieved by the present embodiments of the present invention by comparing prior art solution with the solution according to the present embodiments:
in the prior art solution, the process generally involves at least 4 steps. This in case no headset (wired or wireless) is used by the dialler in which case 3 steps are required if a headset is used by the dialler party.

The four steps are: 1) dial by the dialler party the number (by touch or voice or saying the name of insurance company) of the insurance company; 2) activate by the dialler party the keypad so it is displayed; 3) activate by the dialler party the speaker to better hear the dialled party and 4) press by the dialler party the appropriate key or keys of the keypad.
In the solution according to embodiments herein and as described above, the process involves two steps namely: 1) dial by the dialler party the number (by touch or voice or saying the name of insurance company) of the insurance company; and 2) press/push or select by the dialler party the the appropriate key or keys of the keypad.

It is readily demonstrated above that the embodiments herein save at least 2 process steps compared to the prior art solution which means a reduction in delay to reach the dialler party and also facilitate for the dialler party.

Note also that in the example above when the dialler party is driving the car, the risk for accident is reduced since the driver only needs to select the appropriate key or keys after dialling the number. In the prior art solution, risk for accident is increased since the additional two steps of activating by the driver the keypad and activating by the driver the speaker are needed which leads to less attention of the driver when driving.

Hence the previously described advantages of the embodiments of the invention are fulfilled. The advantages are repeated below:
An advantage with the present embodiments is to reduce significantly the delay for a user i.e. the dialler party of a mobile device to get the appropriate help.
Another advantage with the present embodiments is to simplify for the user i.e. the dialler party of the device to get in contact with the dialled party in a faster way than what is offered with today's solution.
Another advantage with the present embodiments is to provide the dialled party (company or authority or hospital etc. to which the dialler party calls) with a service that helps the dialler getting the appropriate help in a faster needed thereby improving the service offered by the dialled party and thus improving the dialler party's experience.
Yet another advantage with the present embodiments is to provide a mobile user i.e. the dialler party with a downloadable application that can easily be installed and started in a mobile device of the user enabling the user to automatically, without involvement of the user, display and/or activate a keypad of the device and optionally automatically activate a speaker of the mobile device enabling the user to not only see the keypad for appropriate action as described above but also hear the dialled party giving information and/or instructions to the mobile user.

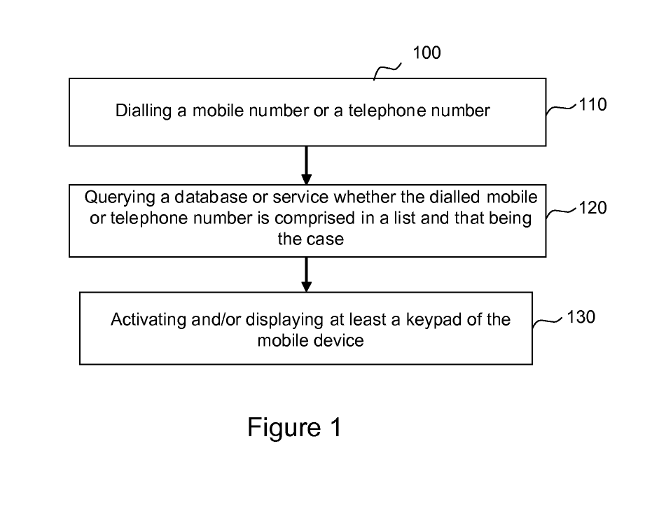

Referring to FIG. 1 there is illustrated exemplary embodiments of a method 100 performed by a mobile device as described earlier. As shown the method comprises:
dialling 110 a mobile number or telephone number belonging to a dialled party or to a party to whom to dial;
querying 120 a database or a server comprising a list of telephone numbers or mobile numbers on whether the dialled mobile or telephone number is comprised in said list;
that being the case i.e. if mobile number or telephone number is comprised in said list,
activating and/or displaying 130 at least a keypad of the mobile device automatically without involving a user of the mobile device; enabling the user to select or push on at least a key of the keypad; wherein the selected or pushed key of the keypad being requested by the dialled party.

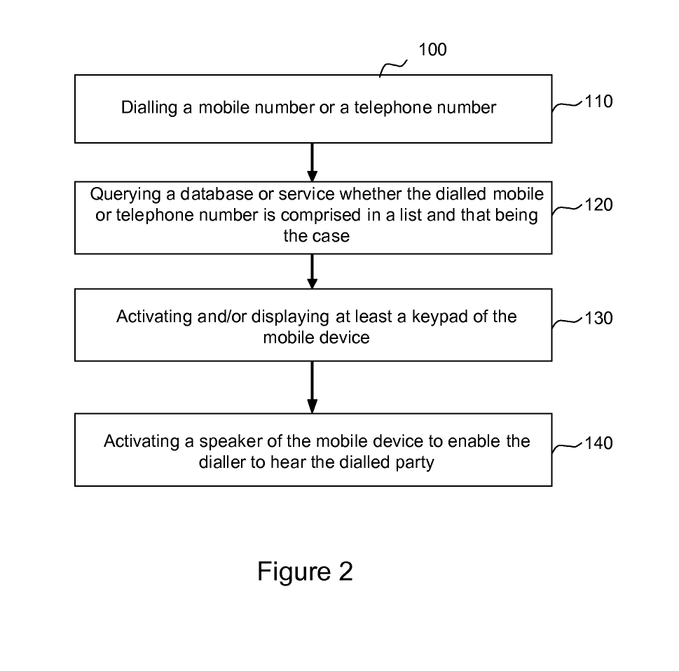

According to an embodiment, activating and/or displaying 130 the at least one keypad further comprising simultaneously activating 140 a speaker of the mobile device enabling the user (dialler party) to hear the dialled party requesting the user of the mobile device to select or push the requested at least one key of the keypad. Method step 140 is shown in FIG. 2 together with the method steps of FIG. 1.

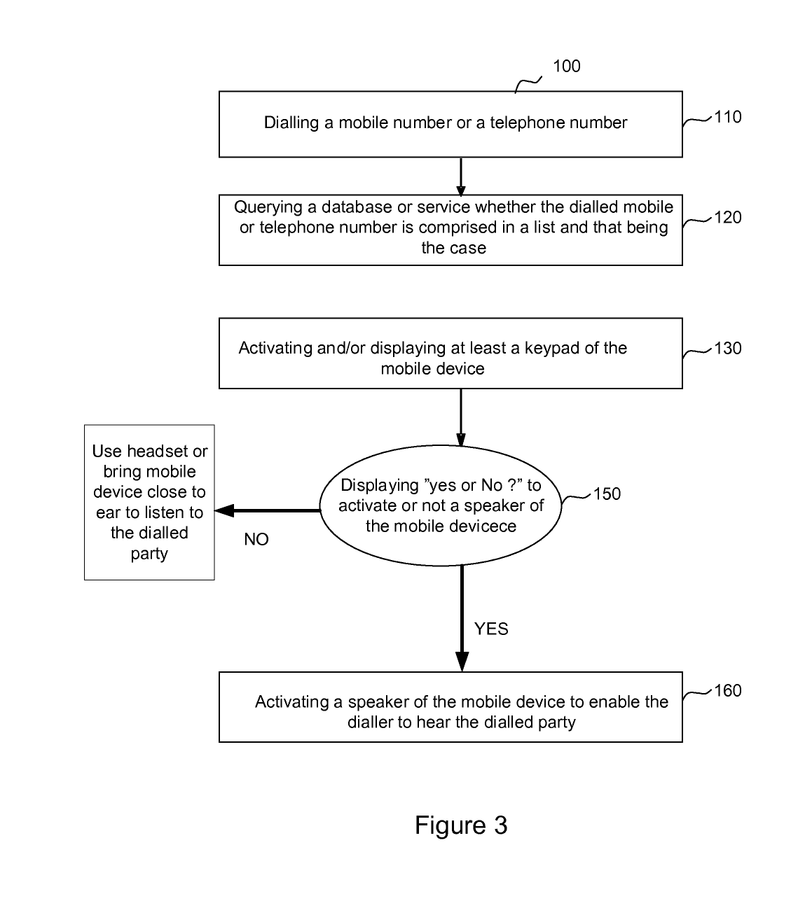

According to an embodiment, activating and/or displaying 130 the at least one keypad further comprising displaying 150 to the user options, e.g. yes or no, on whether to activate or not a speaker of the mobile device enabling the user to select whether to hear the dialled party requesting the user of the mobile device to select or push the requested at least one key of the keypad. This embodiment is shown in FIG. 3.

According to an embodiment, activating 160 the speaker of the mobile device if the user selects the option “yes” enabling the user to hear the dialled party requesting the user of the mobile device to select or push the requested at least one key of the keypad. This method step is shown in FIG. 3. If the user or dialler party selects “no” instead of “yes” the the dialler party may make use of a headset wired or wireless and/or the dialler (or caller) party may bring the mobile device close to the ear to listen in private the dialled (or called) party.

According to an embodiment, selection of the key by the user of the mobile device is performed through voice or through touch of the keypad as previously described. Further according to an embodiment, the method further comprising: following instruction(s) of the dialled party requesting the user of the mobile device to select or push the requested at least one key of the keypad. According to yet another embodiment, the method further comprising: terminating the call generated by the the dialler party of the mobile number or telephone number when the user of the mobile device or the dialled party decides to terminate the call.

The embodiments described above may also apply when receiving a short message service (SMS) e.g. informing the party receiving the SMS that he/she missed a call. The SMS usually includes the number of the the dialled party e.g. 000555 and also sometimes the telephone number or mobile number of the voice mail to dial e.g 123456 in order to listen to missed and saved messages.

Hence in this SMS scenario, assume that he/she dials the number of voice mail 123456, the voice mail normally when responding asks the caller to select or push a key for listening to new messages e.g. “1” or stored messages e.g. “2” etc. Hence making use of the embodiments of the present invention herein, the display is activated/shown enabling the dialler to select or push at least one key of the keypad e.g. “1” for new messages or push “2” for saved messages. According to an embodiment as described above, the speaker of the mobile device of the dialler party is also (simultaneously or after some milliseconds) activated enabling the dialler to hear the automatic voice mail. This way it is faster (short delay) to listen to saved or new messages compared to today's solution.

Hence according to an embodiment, the list of telephone numbers or mobile numbers may also include the telephone or mobile number of the voice mail.

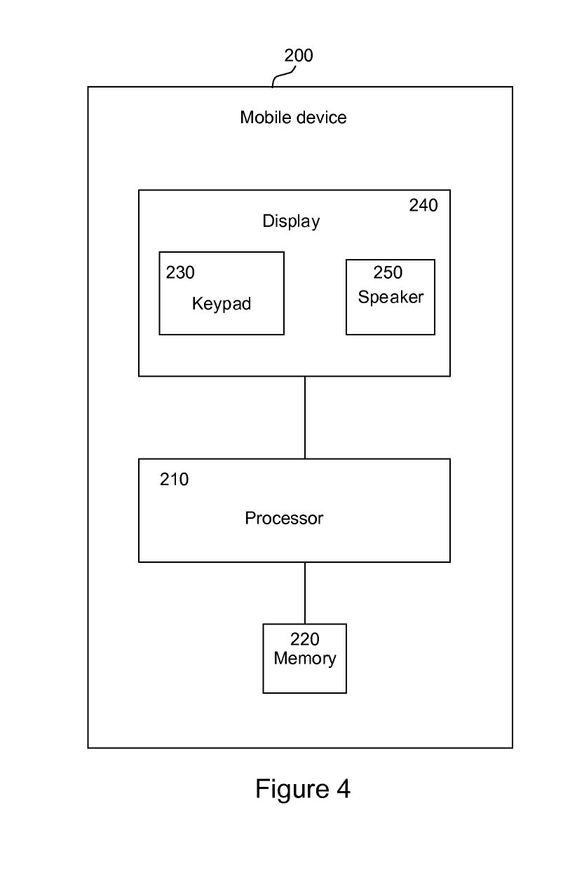

Referring to FIG. 4, there is illustrated a block diagram illustrating an apparatus e.g. a mobile device 200 or user equipment according to embodiments herein.

The mobile device 200 is configured to:
dial a mobile number or telephone number belonging to a dialled party or a party to whom to dial;
query a database or a server comprising a list of telephone numbers or mobile numbers on whether the dialled mobile or telephone number is comprised in said list; and
that being the case i.e. if mobile number or telephone number is comprised in said list,
activate and/or display at least a keypad of the mobile device automatically without involving a user of the mobile device; enabling the user to select or push on at least a key of the keypad; wherein the selected or pushed key of the keypad being requested by the dialled party.

The mobile device 200 is configured to activate and/or display the at least one keypad and is further configured to simultaneously activate a speaker of the mobile device enabling the user to hear the dialled party requesting the user of the mobile device to select or push the requested at least one key of the keypad.

The mobile device 200 is configured to activate and/or display the at least one keypad further comprises the mobile device configured to display to the user options, e.g. yes or no, on whether to activate or not a speaker of the mobile device enabling the user to select whether to hear the dialled party requesting the user of the mobile device to select or push the requested at least one key of the keypad.

The mobile device 200 is further configured to activate the speaker of mobile device if the user selects the option yes enabling the user to hear the dialled party requesting the user of the mobile device to select or push the requested at least one key of the keypad.

The mobile device 200, wherein selection of the key by the user or dialler party of the mobile device is performed through voice or through touch of the keypad.

The mobile device 200 is further configured to follow instruction(s) of the dialled party requesting the user of the mobile device to select or push the requested at least one key of the keypad.

The mobile device 200 is further configured to terminate the call generated by the the dialler of the mobile number or telephone number when the user of the mobile device or the dialled party decides to terminate the call.

As shown in FIG. 4, the mobile device 200 comprises a processor 210 and a memory 220, said memory 220 containing instructions executable by said processor 210 whereby said mobile device 200 is operative to:
dial a mobile number or telephone number belonging to a dialled party;
query a database or a server comprising a list of telephone numbers or mobile numbers whether the dialled mobile or telephone number is comprised in said list; and
that being the case i.e. if mobile number or telephone number is comprised in said list,
activate and/or display at least a keypad 230 of the mobile device automatically without involving a user of the mobile device; enabling the user to select or push on at least a key of the keypad; wherein the selected or pushed key of the keypad being requested by the dialled party. As shown, the mobile device 200 further comprises a display 240 which is used to display the keypad 230 and the speaker 250. Here it is considered that the device 200 may be a smartphone with a touch screen. However, the speaker and/or the keypad are not necessarily part of the display 240. FIG. 4 is only an example. In another example the display may be separate from the speaker and the keypad and instead connected to the display. All the components are connected to the processor 210 or processor module as shown.

According to yet another embodiment herein, there is provided a Computer program, comprising instructions which, when executed on at least one processor e.g. processor 210, cause the at least one processor 210 to carry out the method according to any one of pending claims 1-8 which have also been described above Hence to avoid unnecessary repetitions, the applicant refers to the pending claims 1-8 which are hereby disclosed (see above).

According to yet another embodiment, a carrier containing the computer program above wherein the carrier is one of an electronic signal, optical signal, radio signal, or computer readable storage medium.

In more details, the embodiments herein may be implemented through one or more processors or processing units e.g. processing circuit or unit like processor 210 of FIG. 4 of e.g. mobile device 200 together with a computer program code for performing the functions and/or method steps of the embodiments. For example, a computer program comprising instructions which, when executed on at least one processor, cause the at least one processor to carry out the method performed by the mobile device 300 as described earlier and in conjunction with FIGS. 1 and/or FIG. 2 and/or 3 and presented in the appended method claims. It should be noted that the embodiments herein may be applicable is any system be it second generation (2G); third generation (3G), fourth generation (4G or LTE (Long Term Evolution)); Wifi or WLAN (Wireless Local Area Network); WiMax, CDMA 2000 etc. Hence the solution presented herein is not restricted to any particular mobile system.

It should be mention that the different components of the mobile device 200 may be modules e.g. a keypad module 230; a speaker module 250; a processor module 210; a memory module 220; a display module 240. Other components modules are also present but not shown. For example, an antenna, a receiver/transmitter/transceiver etc. Hence the mobile device 200 is not restricted to only the components shown in the FIG. 4.

The foregoing description of the exemplary embodiment of the present invention has been presented only for the purpose of illustrations and description and is not intended to limit the invention in the form described. Alternative modifications will become apparent to those skilled in the art to which the present invention pertains without departing from its spirit and scope, the Scope of the present invention is defined by the appended claims rather than the foregoing description and exemplary embodiments described therein.

1. A method performed by a mobile device, the method comprising:
dialling one of a mobile number and a telephone number belonging to a dialled party;
querying one of a database or a server comprising a list of one of telephone numbers and mobile numbers to determine whether the one of the dialled mobile number and telephone number is in the list;
if the one of the mobile number and the telephone number is in the list;
at least one of activating and displaying at least a keypad of the mobile device automatically without involving a user of the mobile device and simultaneously activating a speaker of the mobile device, the at least one of the activating and displaying the keypad enabling the user to one of select and push on at least a key of the keypad, the one of the selected and pushed key of the keypad being requested by the dialled party, and simultaneously activating the speaker enabling the user to hear the dialled party requesting the user of the mobile device to one of select and push the requested at least one key of the keypad.

2. The method according to claim 1, wherein selection of the key by the user of the mobile device is performed through one of voice and touch of the keypad.

3. The method according to claim 1, further comprising terminating the call generated by the dialing party of the one of the mobile number and the telephone number when one of the user of the mobile device and the dialled party decides to terminate the call.

4. A mobile device configured to:
dial one of a mobile number and a telephone number belonging to a dialled party or to whom to dial;
query one of a database or a server comprising a list of one of telephone numbers and mobile numbers to determine whether the one of the dialled mobile number and telephone number is in the list; and
if the one of the mobile number and the telephone number is comprised in said the list;
at least one of activate and display at least a keypad of the mobile device automatically without involving a user of the mobile device and simultaneously activating a speaker of the mobile device, the at least one of the activating and displaying the keypad enabling the user to one of select and push on at least a key of the keypad, the one of the selected and pushed key of the keypad being requested by the dialled party, and simultaneously activating the speaker enabling the user to hear the dialled party requesting the user of the mobile device to one of select and push the requested at least one key of the keypad.

5. The mobile device according to claim 4, wherein selection of the key by the user of the mobile device is performed through one of voice and touch of the keypad.

6. The mobile device according to claim 4, further configured to terminate the call generated by the dialing party of the one of the mobile number and the telephone number when one of the user of the mobile device and the dialled party decides to terminate the call.

7. A mobile device comprising:
a processor and a memory, said memory containing instructions executable by the processor to configure the mobile device to:
dial one of a mobile number and a telephone number belonging to a dialled party;
query one of a database or a server comprising a list of one of telephone numbers and mobile numbers to determine whether the one of the dialled mobile number and telephone number is in the list; and
if the one of the mobile number and the telephone number is comprised in said the list;
at least one of activate and display at least a keypad of the mobile device automatically without involving a user of the mobile device and simultaneously activating a speaker of the mobile device, the at least one of the activating and displaying the keypad enabling the user to one of select and push on at least a key of the keypad, the one of the selected and pushed key of the keypad being requested by the dialled party, and simultaneously activating the speaker enabling the user to hear the dialled party requesting the user of the mobile device to one of select and push the requested at least one key of the keypad.

8. A computer storage device storing a computer program comprising instructions which, when executed on at least one processor, cause the at least one processor to:
dial one of a mobile number and a telephone number belonging to a dialled party;
query one of a database or a server comprising a list of one of telephone numbers and mobile numbers to determine whether the one of the dialled mobile number and telephone number is in the list; and
if the one of the mobile number and the telephone number is in the list:
at least one of activate and display at least a keypad of the mobile device automatically without involving a user of the mobile device and simultaneously activating a speaker of the mobile device, the at least one of the activating and displaying the keypad enabling the user to one of select and push on at least a key of the keypad, the one of the selected and pushed key of the keypad being requested by the dialled party, and simultaneously activating the speaker enabling the user to hear the dialled party requesting the user of the mobile device to one of select and push the requested at least one key of the keypad.

9. (canceled)

10. The method according to claim 2, further comprising terminating the call generated by the dialing party of the one of the mobile number and the telephone number when one of the user of the mobile device and the dialled party decides to terminate the call.

11. The mobile device according to claim 2, further configured to terminate the call generated by the dialing party of the one of the mobile number and the telephone number when one of the user of the mobile device and the dialled party decides to terminate the call.
